(19) United States
(12) Patent Application Publication
(10) Pub. No.: US 2018/0018309 A1
(43) Pub. Date: Jan. 18, 2018

(54) AUTOMATICALLY ANNOTATING LITERARY TEXT

(71) Applicant: INTERNATIONAL BUSINESS MACHINES CORPORATION, Armonk, NY (US)

(72) Inventors: Travis Wah CHUN, Coppell, TX (US); Romelia H. FLORES, Coppell, TX (US); Ronald Joseph RUTKOWSKI, II, Coppell, TX (US); Marlenta Ansean JOHNSON, Coppell, TX (US); Roberto Ramon RODRIGUEZ, Coppell, TX (US); Michael Anson LAU, Coppell, TX (US)

(21) Appl. No.: 15/212,728

(22) Filed: Jul. 18, 2016

(51) Int. Cl. G06F 17/24; G06F 17/30

(52) U.S. Cl. CPC G06F 17/241; G06F 17/30657; G06F 17/30864

(57) ABSTRACT

Methods, computer program products, and systems are presented. The methods include, for instance: receiving a request for a response to have a piece of annotative data on a literary text from a user; ascertaining metadata to generate the response is available for the literary device system; identifying a process of the literary device system that is associated with the request; running the process with the request and generating the response based on the metadata; and producing the response to the user such that the user is presented with the annotative data on the literary text.

### TECHNICAL FIELD

The present disclosure relates to literature learning system, and more particularly to methods, computer program products, and systems for a personalized and enhanced learning experience for literatures by use of external data sources based on user profile and real time analysis of request submitted by users.

### BACKGROUND

Classical literature may not be easily comprehended by modern students due to unfamiliar vocabulary and expressions, as well as numerous literary devices that require certain level of analysis to fully understand a subject literary work. Conventional on-line literature learning systems provides a limited range of information based only on the text, and fail to provide multi-dimensional information that engages the modern students.

### SUMMARY

The shortcomings of the prior art are overcome, and additional advantages are provided, through the provision, in one aspect, of a method. The method for automatically annotating a literary text includes, for example: receiving from a user of a literary device system, by one or more processor running the literary device system, a request for a response including a piece of annotative data on the literary text; ascertaining, by the one or more processor, that metadata to generate the response is available for the literary device system; identifying, by the one or more processor, a process of the literary device system that is associated with the request; forwarding, by the one or more processor, the request to the process; generating, by the one or more processor, the response by the process based on the metadata; and producing, by the one or more processor, the generated response to the user such that the user is presented with the annotative data on the literary text.

Additional features are realized through the techniques set forth herein. Other embodiments and aspects, including but not limited to computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts elements of a literary device system (LDS) in a literature learning environment, in accordance with one or more embodiments set forth herein;

FIG. 2 depicts a structure of a menu to be presented via the user interface (UI) of the literary device system (LDS) of FIG. 1, in accordance with one or more embodiments set forth herein;

FIG. 3A depicts screen displays of the literary device system on the user interface, related to a use of the characters menu item, in accordance with one or more embodiments set forth herein;

FIG. 3B is a listing of metadata stored in the literary device system database for the character assessment process, in accordance with one or more embodiments set forth herein;

FIG. 3C depicts screen displays of the literary device system on the user interface, related to a use of the images menu item, in accordance with one or more embodiments set forth herein;

FIG. 3D is a listing of metadata stored in the literary device system database for the image classifier, in accordance with one or more embodiments set forth herein;

FIG. 3E depicts screen displays of the literary device system on the user interface, related to a use of the current events menu item, in accordance with one or more embodiments set forth herein;

FIG. 3F is a listing of metadata stored in the literary device system database for the event process, in accordance with one or more embodiments set forth herein;

FIG. 4 depicts a flowchart for the literary device plug-in (LDPI) on the user node, facilitating the user to interact with the literary device system (LDS), in accordance with one or more embodiments set forth herein;

FIG. 5 depicts a flowchart for the literary device system (LDS), in accordance with one or more embodiments set forth herein;

FIG. 6A is a listing of metadata for the literary analysis sources stored in the literary device system database by the external literary source process, in accordance with one or more embodiments set forth herein;

FIG. 6B is a data type definition of a request for a literary device and a response corresponding to the request, in accordance with one or more embodiments set forth herein;

FIG. 6C depicts examples of requests for a literary device and responses corresponding to the requests pursuant to the data type definition of FIG. 6B, in accordance with one or more embodiments set forth herein;

FIG. 7 depicts a cloud computing node according to an embodiment of the present invention;

FIG. 8 depicts a cloud computing environment according to an embodiment of the present invention; and

FIG. 9 depicts abstraction model layers according to an embodiment of the present invention.

### DETAILED DESCRIPTION

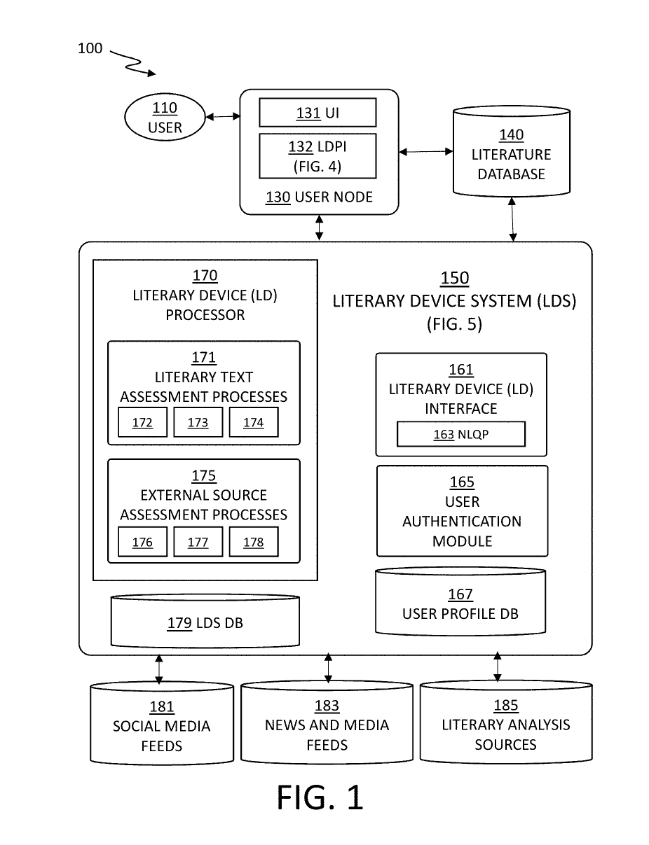

FIG. 1 depicts elements of a literary device system (LDS) 150 in a literature learning environment 100, in accordance with one or more embodiments set forth herein.

The literature learning environment 100 includes a user 110 of at least one user who interacts with a user node 130 corresponding to the user 110, a literature database 140 coupled to both the user node 130 and a literary device system (LDS) 150, and social media feeds 181, news and media feeds 183, and literary analysis sources 185 that are coupled to the LDS 150.

The user 110 uses the user node 130 to access the literary device system (LDS) 150. The user node 130 may be any type of computing device that runs a user interface (UI) 131 and a literary device plug-in (LDPI) 132. The UI 131 facilitates the user 110 to interact with a literary text stored in the literature database 140 and the LDS 150. The UI 131 may be, but not limited to, a typical portable document format (PDF) file reader, a text viewer or a word processor that incorporates the LDPI 132 to obtain access to the LDS 150. The UI 131 displays the literary text and annotative data on the literary text for the user 110 to read and perform further literature analysis on the literary text. The user 110 may be a student, a teacher, an author, a literary expert, or any reader in the literary learning environment 100, who subscribes to the LDS 150 for services of automated literary device analysis and enhanced literary experiences.

In conventional literary learning environments such as literature courses held in classrooms, students often experience difficulty in analyzing pieces of literature and are required to spend a significant number of hours on looking up reference materials and examining the text of the pieces of literature, due to intricate literary devices used in the pieces, and/or due to style and prose of a subject text that are dated and are not easily comprehended by modern students. Although authors of literary works use “literary devices”, also referred to as “literary techniques”, to convey certain messages to readers with certain psychological effects in the minds of the readers, the literary devices are easily misconstrued by the readers. The readers may get help in learning a piece of literature by using on-line literary analysis sites such as CliffNotes and SparkNotes, which offer easy-to-read study guides, including chapter summaries, literary devices, character analysis, and discussion forums on works of literature and academic subjects. (SparkNotes is a trademark of SparkNotes LLC in the United States and other countries; CliffNotes is a trademark of Houghton Mifflin Harcourt in the United States and other countries)

However, these literary analysis sites provide information limited to one site and fail to integrate information from numerous data sources and to correlate information for the readers.

Embodiments of the present invention provide a menu-based user interface, support natural language queries, and formulate a request for annotative data on the literary text based on input from a user such that the readers may conveniently analyze the literary text with minimal knowledge on literary devices. The embodiments of the present invention also provide dynamic and real-time search results integrating multiple search results in response to one request that conventionally require numerous manual searches by the users, by use of automated external data source search and processing based on a request from the user, and establishing a database storing metadata for literary devices and external data. The embodiments of the present invention enhance learning experience of the users by adding current and relevant information, from popular sources that modern users have great interest, to the literary text. Consequently, the readers may understand the literary text significantly better than utilizing static and limited literary analysis information as in conventional literary analysis sites.

The literary device plug-in (LDPI) 132 interconnects the literary device system (LDS) 150 with the UI 131. The LDPI 132 provides pop-up menu fields displayed via the UI 131 for the user 110 to navigate and select from the provided pop-up menu fields, as well as facilitate the user 110 to input a natural language query by use of input text field or voice recognition via the UI 131. The LDPI 132 processes input from the UI 131 as provided by the user 110, forms a request for annotative data on the literary text according to a user input from the UI 131, then send the request to the LDS 150. The LDPI 132 receives a response corresponding to the request from the LDS 150 and forwards the response to the UI 131 for presentation to the user 110.

The literature database 140 is a digital repository of literary works including the literary text, which may be obtained via the Internet or provided by the user 110. The user 110 had previously purchased the literary text or otherwise has a legitimate access to the literary text. The user 110 opens and reads the literary text stored in the literature database 140 by use of the UI 131. The LDS 150 utilizes the literature database 140 to obtain literary works for analysis and for generating responses for a request from the user 110.

The literary device system (LDS) 150 interacts with the user node 130 and the literature database 140 as well as external data sources including the social media feeds 181, the news and media feeds 183, and the literary analysis sources 185. The LDS 150 includes a literary device (LD) interface 161, a user authentication process 165, a user profile database (DB) 167, a literary device (LD) processor 170 and a literary device system database (LDS DB) 179.

The LD interface 161 provides content to be presented to the user 110 via the UI 131 and the LDPI 132 such as pop-up menu fields with which the user 110 may interact. The pop-up menu fields provided for the user 110 corresponds to functionalities of the LDS 150. The LD interface 161 of the LDS 150 directly interacts with the LDPI 132 of the user node 130 to accommodate communication between the user 110 and the LDS 150. The LD interface 161 receives a request from the LDPI 132, analyzes the request, determines which information should be generated in response to the request, and forwards the request to one or more process in the LD processor 170 that has functionality to generate the information responsive to the request.

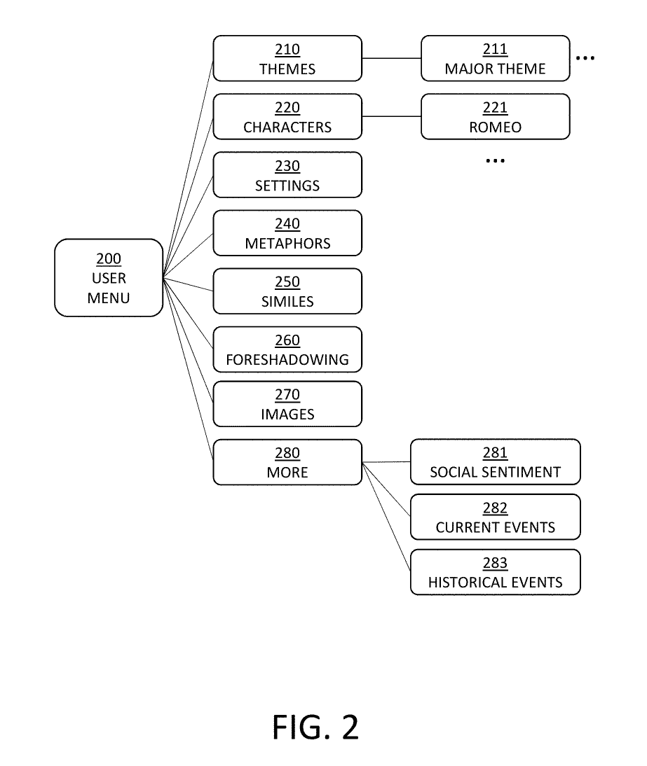

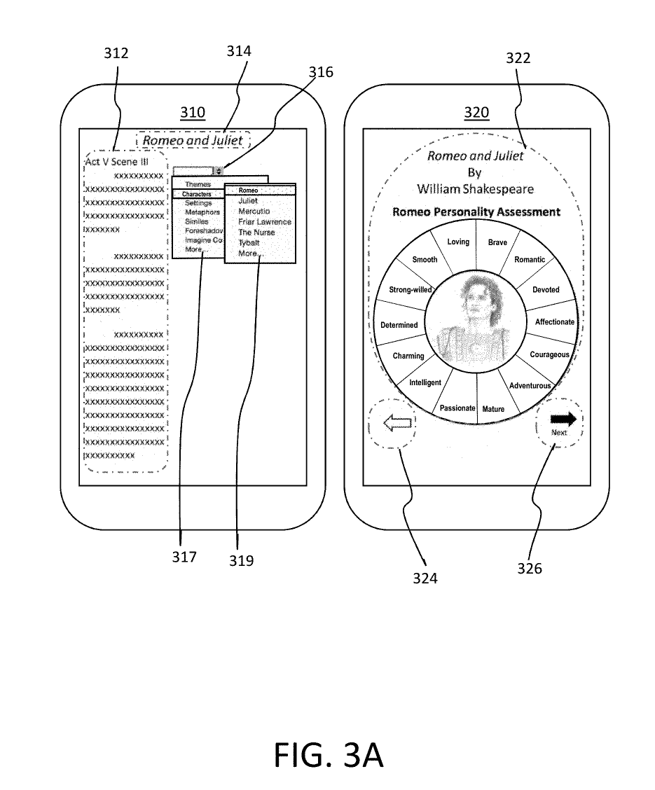

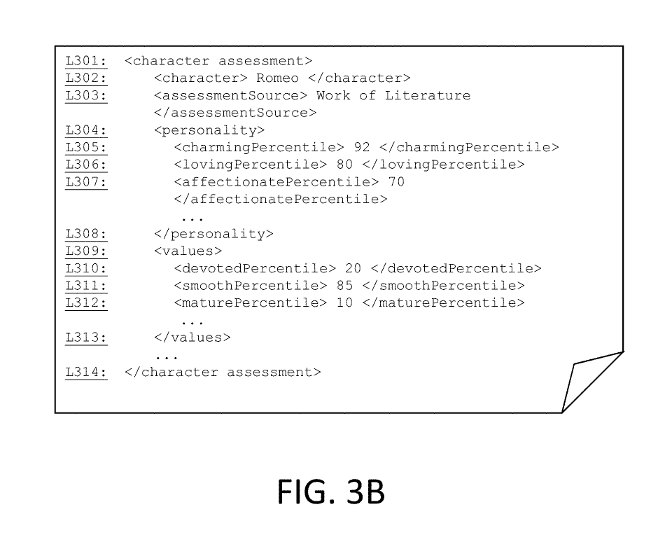

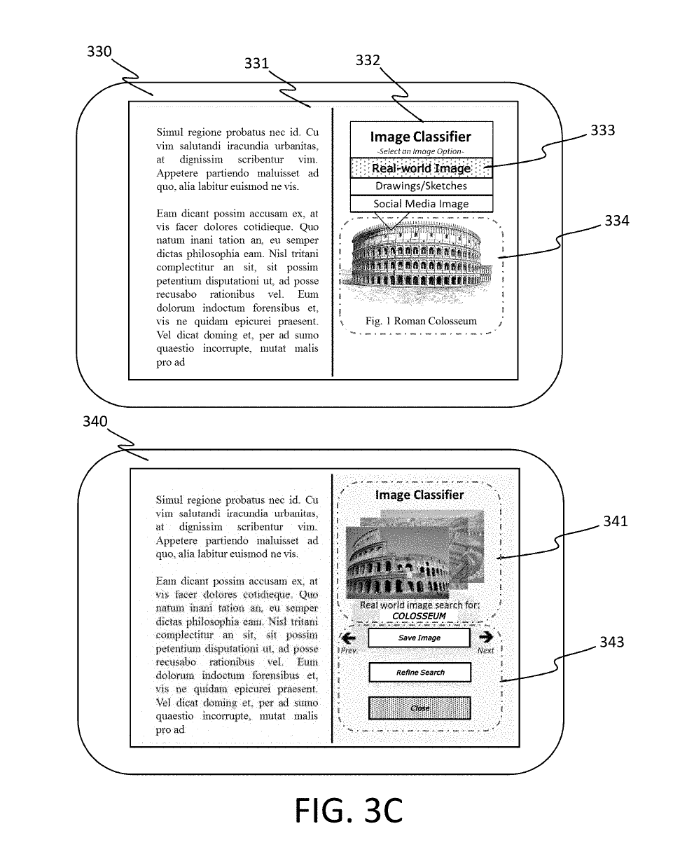

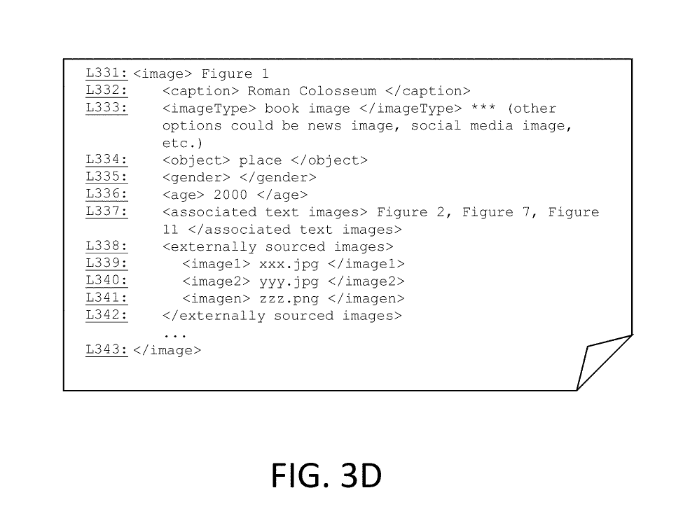

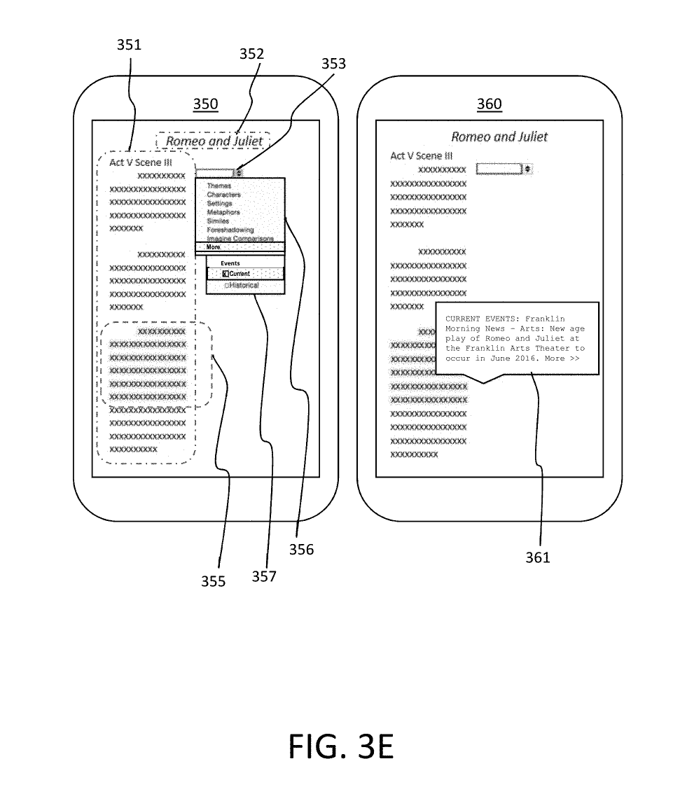

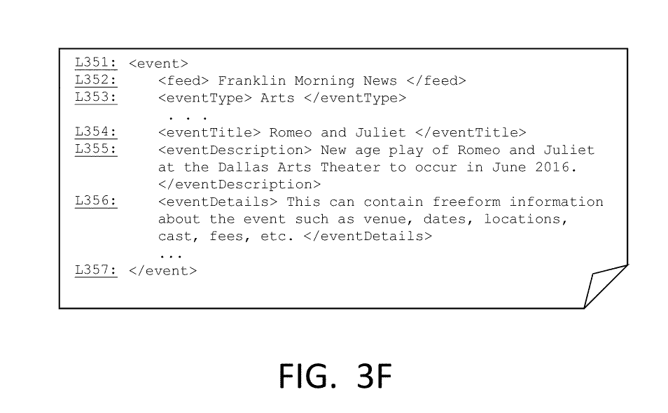

In one embodiment of the present invention, the pop-up menu fields are organized in more than one levels such that sub-menu items corresponding to a selected menu item are displayed subsequent to a first selection by the user 110. See FIGS. 2, 3A, 3C, and 3E and corresponding descriptions for details of the pop-up menu fields in the same embodiment.

The LD interface 161 includes a natural language query processor (NLQP) 163 to process the request from the user 110 if the request is given as a natural language query via the UI 131 other than contents corresponding to the pop-up menu fields of the LDPI 132. Accordingly, the LD interface 161 may determine annotative data on the literary text requested by the user 110 where the request is given by either a selection from the pop-up menu via the LDPI 132 or a natural language query via the UI 131, and subsequently may invoke the one or more process of the LD processor 170 to obtain the information that the LD interface 161 had determined to be requested by the user 110. The LD interface 161 also coordinates information returned from the one or more processes of the LD processor 170 and present a response corresponding to the request to the user 110 via the LDPI 132 and via the UI 131.

In one embodiment of the present invention, the NLQP 163 processes a natural language query from the user 110 with regard to a selected block of text stating “where does Romeo make bad choices”. The NLQP 163 analyzes the request and generates a request for the LD interface 161 to inquire a list of decisions made by Romeo that had adverse consequences from the LD processor 170, or apply any criteria correlated to the word “bad”.

The user authentication process 165 provides subscription security services in support of the LDPI 132 by checking login credentials provided by the user 110 to identify the user 110 and to determine a level of access of the user 110 to the LDS 150 services, and records a user profile corresponding to the user 110 in the user profile DB 167. When the user 110 first requests literary device information via the UI 131, a set of username and password for the user 110 is sent to the LD interface 161 that invokes the user authentication process 165. While registering an account with the LDS 150 for the user 110, the user profile indicating a user-specific configuration on how to use the LDS 150 is created in the user profile DB 167. Examples of information in the user profile may be, but are not limited to, a media preference indicating which of the social media feeds 181 the user 110 subscribes to and prefers as a source of data, a retention period indicating how long to retain cached external data, etc. The user profile DB 167 stores login credentials including sets of username and password as well as user profiles including preference as to the usage of the LDS 150, respectively for all users of the LDS 150.

The LD processor 170 collectively refers to two groups of functional processes, literary text assessment processes 171 and external source assessment processes 175. The LD processor 170 include all processing processes that are required for the functionalities of the LDS 150 to appropriately access external data sources, to analyze the literary text and the external data in processing the request from the user 110. The LD processor 170 further controls access to a literary device system database (LDS DB) 179, storing metadata for the literary device analysis data, social media data, event and news data, which had been processed and analyzed within the LDS 150.

The literary text assessment processes 171 of the LD processor 170 perform cognitive analysis of text and images of a work of literature to provide proper responses to requests submitted to the LDS 150. An individual process of the literary text assessment processes 171 analyzes parts of the work of literature according to the request from the user 110 that are relevant to a functionality of the individual process.

In one embodiment of the present invention, the literary text assessment processes 171 include a character assessment process 172, a literary device analyzer 173, and an image classifier 174. The character assessment process 172 amongst the literary text assessment processes 171 collects dialogs and description of characters in the work of literature subject to the request and analyzes the collected data such that the LDS 150 creates a personality profile for each character appearing in the work of literature. Accordingly, the user 110 may understand the work of literature better by utilizing an insight for personality traits and values of the characters in the work of literature as provided in the personality profiles while reading the literary text. As shown in FIG. 2, one embodiment of the LDS 150 may provide analysis for characters 220, respective to individual character including Romeo 221, etc. See FIGS. 3A and 3B, and corresponding descriptions for an example of a request for character assessment for Romeo from Romeo and Juliet by William Shakespeare, a response provided by the LDS 150 as presented to the user 110, and a metadata of a personality profile for Romeo.

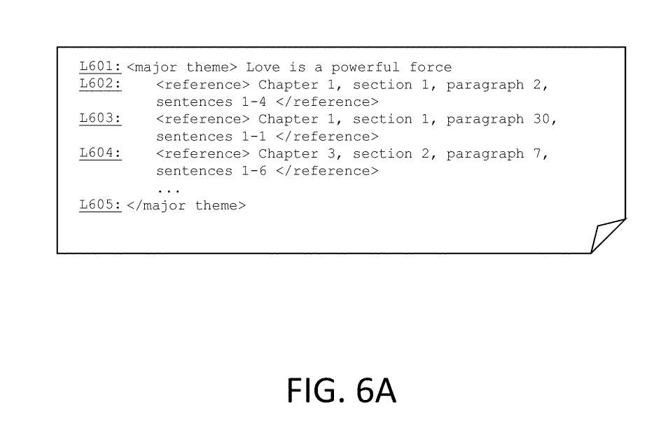

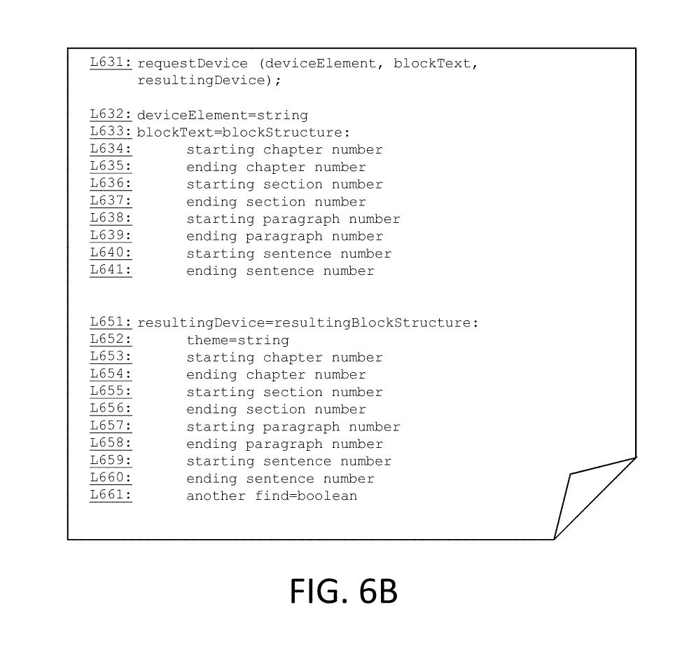

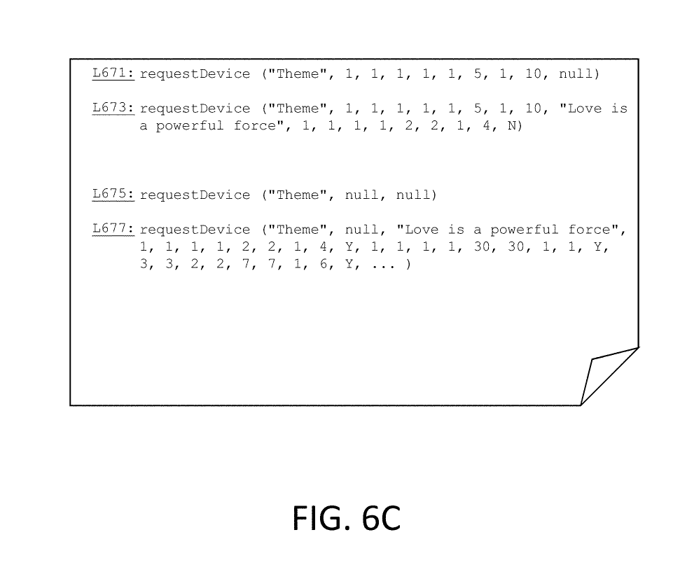

The literary device analyzer 173 amongst the literary text assessment processes 171 examines a block of text from the work of literature as selected by the user 110 from the request and determines which literary devices, if any, are used. As shown in FIG. 2, one embodiment of the LDS 150 may provide analyses for the literary devices such as themes 210, settings 230, metaphors 240, similes 250, and foreshadowing 260. For example, if the user 110 had requested thematic elements from a block of text by selecting Themes from a menu screen 317 of FIG. 3A, the literary device analyzer 173 identifies related themes from the selected block and provides a response that highlights themes within the block as found for the user 110. Similarly, any literary device configured to be supported by the literary device analyzer 173, such as settings, metaphors, etc., in the present embodiment. In the same embodiment, a literary device of metaphor with selected text for an idiom “elephant in the room” is analyzed and responded by the literary device analyzer 173 as “an obvious truth that is going unaddressed; an obvious problem or risk no one wants to discuss”. See FIGS. 6A, 6B and 6C, and corresponding descriptions for an example of metadata, a request and response formats for an exemplary literary device of theme.

The image classifier 174 amongst the literary text assessment processes 171 analyzes the text and content in the work of literature and correlates the text to specific search terms for an image search, identifies images in the work of literature, extracts key information, and correlates the extracted key information to other images in the work of literature. For example, after identifying an illustration of a mountain, the image classifier 174 detects all references of mountains as symbolism, similes, metaphors, etc., within the work of literature. For another example, if the image classifier 174 identifies an image in the work of literature, which may be associated with a real-world entity such as the Roman Colosseum, then the user is presented with options to choose from as to kind of images of the real-world entity. See FIGS. 3C and 3D, and corresponding descriptions for an example of an option for a request to and a response from the image classifier 174, and a metadata of images for the Roman Colosseum.

The external source assessment processes 175 of the LD processor 170 collect data from external data sources and analyze collected data to set up a base literary analysis of the work of literature. In one embodiment of the present invention, the external source assessment processes 175 include a social media process 176, an events process 177, and an external literary source process 178.

The social media process 176 amongst the external source assessment processes 175 extracts data from social media postings and feeds that are related to literary aspects of the work of literature such as plots, the author, themes and other literary devices. For example, when a user of Twitter posts a tweet in support of a main character of the work of literature, the posting is classified as positive character sentiment such that the user 110 of the LDS 150 may understand better how the main character is generally received. After social media data relevant to the work of literature are extracted from social media subject to collection by the social media process 176, the social media process 176 generates metadata corresponding to respective piece of social media data and stores the generated metadata in the LDS DB 179. The social media process 176 later respond to a request directed to the social media process 176 by the LD interface 161 based on the metadata stored in the LDS DB 179.

The events process 177 amongst the external source assessment processes 175 extracts data from news media feeds that are related to any aspects of the work of literature such as plots, the author, themes, settings, characters, historical and current events relevant to the work of literature. For example, a news article that celebrates the 20th anniversary of publication of a book and a historical context regarding when the book was written may be gathered from respective news media sources. After news media data relevant to the work of literature are gathered from news media subject to collection by the events process 177, the events process 177 generates metadata corresponding to respective piece of news media data and stores the generated metadata in the LDS DB 179. The events process 177 later respond to a request directed to the events process 177 by the LD interface 161 based on the metadata stored in the LDS DB 179.

The external literary source process 178 amongst the external source assessment processes 175 gathers basic literary analysis data relevant to the work of literature from external literary sources such as CliffNotes. After data relevant to the work of literature are gathered from external literary sources subject to collection by the external literary source process 178, the external literary source process 178 generates metadata corresponding to respective piece of external literary source data and stores the generated metadata in the LDS DB 179. The external literary source process 178 later respond to a request directed to the external literary source process 178 by the LD interface 161 based on the metadata stored in the LDS DB 179.

The literary device system database (LDS DB) 179 stores both structured and unstructured data from the literature database 140 as well as a collection of metadata generated by the LD processor 170, as described in the description above, based on external data sources including the social media feeds 181, the news and media feeds 183, and the literary analysis sources 185 such as internet literature study guides, dictionaries, literary device terminology, etc. The LDS DB 179 is referenced by the respective processes of the LD processor 170 to analyze the request from the user 110 and to generate the response corresponding to the request. As previously noted, the processes of the LD processor 170 build the LDS DB 179 by storing new information gathered from various external data sources to the LDS DB 179 for analysis in the process of responding to each request.

The social media feeds 181 represent one of the data sources external to the LDS 150 that is collected from postings of one or more social media, for information relevant to the literary text. The social media feeds 181 may be publicly available via the Internet, or may be accessible on subscription-based and/or with user permissions. Numerous data formats may be employed for the social media feeds 181 including any combination of text, image, audio, and video. Examples of social media may be Facebook, Twitter, etc.

The news and media feeds 183 represent one of the data sources external to the LDS 150 that is collected from postings of one or more news media, for information relevant to the literary text. Similarly to the social media feeds 181, the news and media feeds 183 may be publicly available via the Internet, or may be accessible on subscription-based, and multimedia data formats may be employed including any combination of text, image, audio, and video.

The literary analysis sources 185 represent external sources of basic literary analysis that the LDS 150 imports in order to initialize an analysis process of the LDS 150. The literary analysis sources 185 feeds may be publicly available via the Internet, or may be accessible on subscription-based. The literary analysis sources 185 may provide multimedia data formats including any combination of text, image, audio, and video.

FIG. 2 depicts a structure of a user menu 200 to be presented via the user interface (UI) 131 of the literary device system (LDS) 150 of FIG. 1, in accordance with one or more embodiments set forth herein.

In this embodiment of the present invention, the user menu 200 is a series of pop-up menus organized in two (2) levels. A top-level user menu includes menu items labeled as themes 210, characters 220, settings 230, metaphors 240, similes 250, foreshadowing 260, images 270, and more 280. The user menu 200 represents exemplary types of annotative data on the literary text, as demanded in the request from the user to the LDS 150 of FIG. 1.

For the themes 210 menu item, the characters 220 menu item, the settings 230 menu item, the metaphors 240 menu item, the similes 250 menu item, and the foreshadowing 260 menu item, a literary device identified by the label of respective menu items is analyzed when a user selects one of the menu items. See FIGS. 6A, 6B, and 6C and corresponding description for details of processes when the user selects the themes 210 menu item. See FIGS. 3A and 3B and corresponding description for details of processes when the user selects the characters 220 menu item. The rest of menu items 230, 240, 250, and 260 may be processed similarly to the examples in the themes 210 and the characters 220 menu items, in a manner configured for respective literary device. For example, when the user selects the setting 230 menu item, the LDS 150 identifies settings such as periodical and geographical background of the literary text to assist the user to understand the literary text. Similarly for another example, when the user selects the metaphors 240 menu item, the LDS 150 may highlight phrases of the literary text wherein a metaphor is used, and/or further analyze the metaphor word-by-word in detail. For still another example, when the user selects the similes 250 menu item, the LDS 150 may identify phrases employing similes in the literary text, and/or further provide detailed information on the identified similes as to how often and which kinds of the similes are used throughout the literary text. For still another example, when the user selects the foreshadowing 260 menu item, the LDS 150 may identify phrases employing foreshadowing within the literary text by pointing out the phrases and relating the phrases to a respective reference to an event that the foreshadowing insinuated, and/or further analyze on frequencies and types of events signaled by use of the foreshadowing.

For the images 270 menu item, a functionality presenting various images relevant to a literary work as provided by the image classifier 174 of FIG. 1. The top level menu items may expand to a sub-menu respectively corresponding to the top-level menu items, upon being selected by a user. For example, the themes 210 menu item has a sub-menu including major theme 211, and the characters 220 menu item has a sub-menu listing names of individual characters in the literary text, such as Romeo 221 wherein the literary text is a play “Romeo and Juliet” authored by William Shakespeare, which had been originally published in 1597. The major theme 211 may have a third level sub-menu, as represented by an ellipsis ( . . . ) on the right side of the major theme 211. Similarly, another ellipsis ( . . . ) under Romeo 221 represents that the characters 220 menu item has other sub-menus respective to other characters of the literary text, as shown in 319 of FIG. 3A. The more 280 menu item has a sub-menu including items labeled as social sentiment 281, current events 282, and historical events 283, respectively identifying information that may be requested from the external data sources by use of the LDS 150 of FIG. 1. See FIGS. 3A, 3C, and 3E for examples of the user menu 200 in showing the characters 220 menu item, the images 270 menu item, and the current events 282 menu item, respectively.

FIG. 3A depicts screen displays of the literary device system 150 of FIG. 1 on the user interface 131 of FIG. 1, related to a use of the characters menu item 220 of FIG. 2, in accordance with one or more embodiments set forth herein.

A first screen display 310 initially includes a text area 312 of a literary work, a title area 314 of the literary work, and a pop-up menu window 316. When a user of the literary device system (LDS) 150 of FIG. 1 triggers the pop-up menu window 316 by clicking, hovering or tapping on the user node 130 of FIG. 1, a top-level menu 317 drops down from the pop-up menu window 316. When the user selects the characters menu item from the top-level menu 317 as marked by a shaded box “Characters” within the top-level menu 317 area, then a sub-menu 319 of the characters menu item appears. In the first screen display 310, the user selects a first main character “Romeo” from the sub-menu 319 as marked by another shaded box “Romeo” within the sub-menu 319 area.

A second screen display 320 shows a response the user receives from the LDS 150 responsive to making a request for character assessment in the first screen display 310. The request is formatted and passed onto the character assessment process 172 of the LDS 150, then the character assessment process 172 processes the request and generates the response and returns to the user node. In a response area 322 of the second screen display 320, the title and the author of the literary work “Romeo and Juliet By William Shakespeare”, a label for the response “Romeo Personality Assessment”, and the response as configured by the literary device plug-in (LDPI) 132 of FIG. 1 are shown. The response is in a format combining a representative image of the character “Romeo” at the center and a list of adjectives that describes personality of the character “Romeo” circling the representative image in a ring configuration. A backward arrow 324 pointing to the left side of the screen and a forward arrow 326 pointing to the right side of the screen are displayed for the user to further interact with the LDS 150. In the second screen display 320, the forward arrow 326 is also labeled “Next”, indicating that the user may see further attributes of the character “Romeo”, or personality assessment of another character in the literary work, etc. The forward arrow 326 is displayed in a darker color than the backward arrow 324 to show availability distinctive from the backward arrow 324.

FIG. 3B is a listing of metadata stored in the literary device system database 179 for the character assessment process 172 of FIG. 1, in accordance with one or more embodiments set forth herein.

The literary device system database (LDS DB) 179 of FIG. 1 stores data relevant to personality assessment for at least main characters of a literary work. In one embodiment of the present invention, the external literary source process 178 of the LDS 150 initially processes personality assessment data from text of the literary work in the process of importing basic literary analysis data from the literary analysis sources 185 to set up the LDS DB 179. In another embodiment of the present invention, all external data sources 181, 183, and 185, may be initially processed for personality assessment. The external literary source process 178 stores metadata of the personality assessment data in the LDS DB 179 such that the personality assessment data is usable by other processes of the LDS 150, particularly for the character assessment process 172.

In one embodiment of the present invention, metadata is generated in Extensible Markup Language (XML) format. Tags in the lines L301 <character assessment> and L314 </character assessment> mark where the root element “character assessment” begins and ends, respectively. Within the character assessment element, line L302 represents a first attribute “character” of the “character assessment” element, indicating that the character assessment in lines L301 through L314 is for a character identified as “Romeo”. Within the character assessment element, line L303 represents a second attribute “assessmentSource”, indicating that a source on which the character assessment element in lines L301 through L314 is based is the source identified as “Work of Literature”, indicating that the literary text is and/or had been analyzed for the character assessment. Within the character assessment element, lines L304 through L308 represent a first subelement of the “character assessment” element, and lines L309 through L313 represent a second subelement “values” of the “character assessment” element. The “personality” subelement has attributes of “charmingPercentile” in line L305, “lovingPercentile” in line L306, and “affectionatePercentile” in line L307, which have values 92, 80, and 70, respectively. The “values” subelement has attributes of “devotedPercentile” in line L310, “smoothPercentile” in line L311, and “maturePercentile” in line L312, which have values 20, 85, and 10, respectively.

FIG. 3C depicts screen displays of the literary device system 150 of FIG. 1 on the user interface 131 of FIG. 1, related to a use of the images menu item 270 of FIG. 2, in accordance with one or more embodiments set forth herein.

A third screen display 330 initially includes the text area 331 of the literary work, and a figure area 334 of the literary work. When the user of the literary device system (LDS) 150 of FIG. 1 triggers a pop-up menu of the image classifier 332 to be displayed by signaling on the user node 130 of FIG. 1 in the figure area 334. The pop-up menu of the image classifier 332 includes, for example, a name of the process “Image Classifier” and a direction on how to use the pop-up menu of the image classifier 332 stating “Select on Image Option”. The pop-up menu of the image classifier 332 also includes, options “Real-world Image”, “Drawings/Sketches”, and “Social Media Images”. The user selects a first option “Real-world Image”, as indicated by a shaded box “Real-world Image” 333.

A fourth screen display 340 shows a response the user receives from the LDS 150 responsive to making the request for real-world images from the third screen display 330. The request is formatted and passed onto the image classifier 174 of the LDS 150, then the image classifier 174 processes the request and generates the response and returns to the user node. In a first response area 341 of the fourth screen display 340, the “Image Classifier” representing a functionality of the LDS being used, one or more images produced by the LDS 150 as requested, and a caption describing the images “Real world image search for: COLOSSEUM” are displayed. In a second response area 343, several options are displayed for the user to further interact with the LDS 150. The user may select a backward arrow labeled “Prev.” to revisit a previous image, a forward arrow labeled “Next” to see a next image, a “Save Image” button to store a current image, a “Refine Search” button to narrow search parameters, or a “Close” button to end the image classifier function.

FIG. 3D is a listing of metadata stored in the literary device system database 179 for the image classifier 174 of FIG. 1, in accordance with one or more embodiments set forth herein.

The literary device system database (LDS DB) 179 of FIG. 1 stores data relevant to figures appearing in a literary work. In one embodiment of the present invention, metadata representing the data relevant to figures of the literary work is generated in Extensible Markup Language (XML) format. Tags in the lines L331 <image> and L343 </image> mark where the root element “image” begins and ends, respectively.

Within the image element, line L332 represents a first attribute “caption” of the image element, which has a value “Roman Colosseum”, indicating that the image element in lines L331 through L343 is for a figure textually described as “Roman Colosseum”.

Within the image element, line L333 represents a second attribute “imageType” of the image element, which has a value “book image”, indicating that the image element in lines L331 through L343 is a figure from the literary text, among many origins of images such as “news image” indicating that the source of the image element is a news media, “social media image” indicating that the source of the image element is a social media, etc.

Within the image element, line L334 represents a third attribute “object” of the image element, which has a value “place”, indicating that the image element in lines L331 through L343 is an image of a specific place and/or a geographical location.

Within the image element, line L335 represents a fourth attribute “gender” of the image element, which has a null value, indicating that the image element in lines L331 through L343 is not assigned with a gender information.

Within the image element, line L336 represents a fifth attribute “age” of the image element, which has a numeric value two thousand (2000), indicating that the image element in lines L331 through L343 is depicting a two-thousand year old subject.

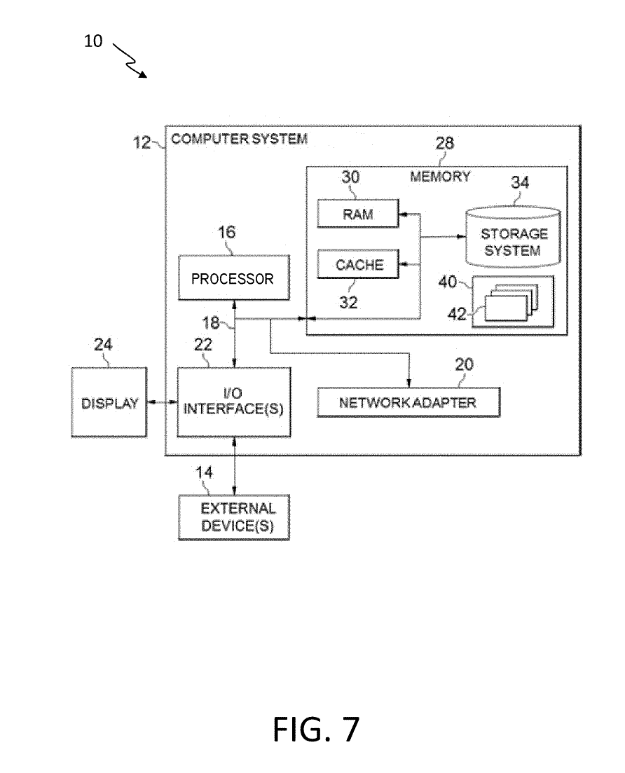

Within the image element, line L337 represents a sixth attribute “associated text images” of the image element, which has a value “FIG. 2, FIG. 7, FIG. 11”, indicating that the image element in lines L331 through L343 is related to other figures listed in the value “FIG. 2, FIG. 7, FIG. 11” from the literary text.

Within the image element, lines L338 through L342 represent a first subelement “externally sourced images” of the image element, which has three subelements of “image1” having a value “xxx.jpg” in line L339, “image2” having a value “yyy.jpg” in line L340, and “imagen” having a value “zzz.png” in line L341, respectively indicating a name of a image file that had been collected by the literary device system from external data sources.

FIG. 3E depicts screen displays of the literary device system 150 of FIG. 1 on the user interface 131 of FIG. 1, related to a use of the current events menu item 282 of FIG. 2, in accordance with one or more embodiments set forth herein.

A fifth screen display 350 initially includes a text area 351 of a literary work, a title area 352 of the literary work, and a pop-up menu window 353. When a user of the literary device system (LDS) 150 of FIG. 1 selects a block of text 355 from the text area 351 and activates the pop-up menu window 353, a top-level menu 356 drops down from the pop-up menu window 353. When the user selects the more menu item from the top-level menu 356 as marked by a shaded box “More” within the top-level menu 356 area, then a sub-menu 357 of the more menu item appears. In the fifth screen display 350, the user selects a checkbox next to a “Current” label under a heading “Events” from the sub-menu 357 as marked by another shaded box “[x] Current” within the sub-menu 357 area, indicating that the user makes a request for information on current events related to the selected block of text 355.

A sixth screen display 360 shows a response the user receives from the LDS 150 responsive to making a request for current events in the fifth screen display 350. The request is formatted and passed onto the events process 177 of the LDS 150, then the events process 177 processes the request and generates a response and returns the response to the user node. In a pop-up response bubble 361 of the sixth screen display 360, a description of an event shown in metadata of FIG. 3F is displayed. In the sixth screen display 360, the block of text 355 that had been selected by the user in the fifth screen display 350 remains highlighted.

FIG. 3F is a listing of metadata stored in the literary device system database 179 for the event process 177 of FIG. 1, in accordance with one or more embodiments set forth herein.

The literary device system database (LDS DB) 179 of FIG. 1 stores current and historical event data relevant to a literary work, as collected from the external data sources including the news and media feeds 183. In one embodiment of the present invention, metadata representing an event relevant to the literary work is generated in Extensible Markup Language (XML) format as shown. Tags in the lines L351 <event> and L357 </event> mark where the root element “event” begins and ends, respectively.

Within the event element, line L352 represents a first attribute “feed” of the event element, which has a value “Franklin Morning News”, indicating that data for the event element in lines L351 through L357 has been collected from a news feed provided by an organization “Franklin Morning News”.

Within the event element, line L353 represents a second attribute “eventType” of the event element, which has a value “Arts”, indicating that the event element in lines L351 through L357 is an artistic event.

Within the event element, line L354 represents a third attribute “eventTitle” of the event element, which has a value “Romeo and Juliet”, indicating that the event element in lines L351 through L357 may be identified by a title “Romeo and Juliet”.

Within the event element, line L355 represents a fourth attribute “eventDescription” of the event element, which has a value “New age play of Romeo and Juliet at the Dallas Arts Theater to occur in June 2016.”, indicating that the event element in lines L351 through L357 may be described according to the value of the eventDescription attribute as provided. The pop-up response bubble 361 of FIG. 3E displays the value of the feed, eventType and eventDescription attributes.

Within the event element, line L356 represents a fifth attribute “eventDetails” of the event element, which has a value “This can contain freeform information about the event such as venue, dates, locations, cast, fees, etc.”, indicating that the event element in lines L351 through L357 may be further described according to the value of the eventDetails attribute as provided. In one embodiment of the present invention, when the user clicks “More>>” from the pop-up response bubble 361 of FIG. 3E, the pop-up response bubble 361 expands and the value of the eventDetails attribute is displayed following the value of the eventDescription attribute.

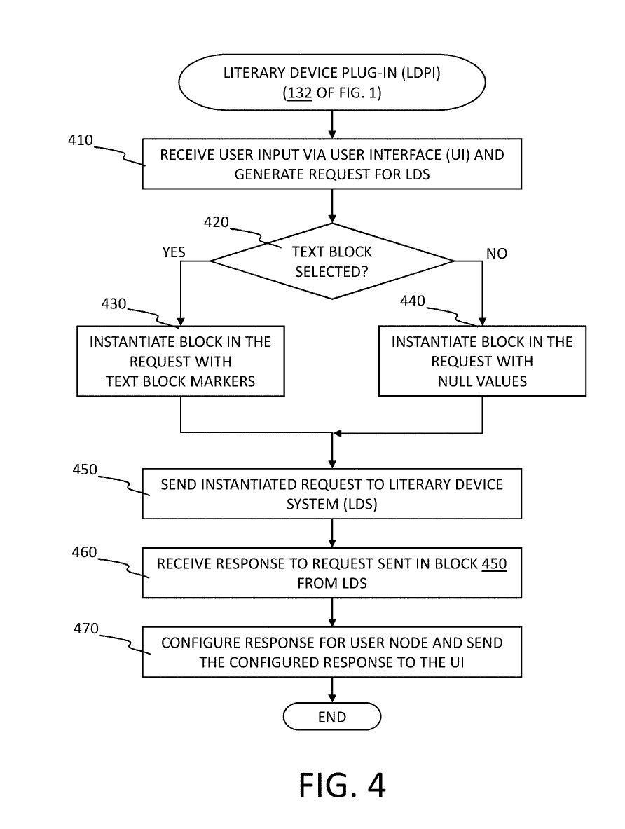

FIG. 4 depicts a flowchart for the literary device plug-in (LDPI) 132 of FIG. 1 on the user node 130, facilitating the user to interact with the literary device system (LDS) 150 of FIG. 1, in accordance with one or more embodiments set forth herein.

In block 410, the LDPI 132 of FIG. 1 receives input from the user 110 of the user node 130 of FIG. 1 via the user interface (UI) 131 of FIG. 1 and generates a request for annotative data on the literary text to the LDS 150 based on the input. The input from the user 110, also referred to as the user input, may include a menu item as selected by the user 110, a natural language query submitted by the user 110, a block of text from the literary text as selected by the user 110. Then the LDPI 132 proceeds with block 420.

In block 420, the LDPI 132 determines whether or not the user input from block 410 includes the block of text selected by the user 110. If the LDPI 132 determines that the received user input includes the block of text selected by the user, then the LDPI 132 proceeds with block 430. If the LDPI 132 determines that the received user input does not include a block of text selected by the user 110, then the LDPI 132 proceeds with block 440.

In block 430, the LDPI 132 instantiates a block element in the request with markers identifying the range of the block of text selected by the user 110 as confirmed from block 420. See FIGS. 6B and 6C and corresponding descriptions for an exemplary request format and examples of requests for the literary device of theme. Then the LDPI 132 proceeds with block 450.

In block 440, the LDPI 132 instantiates a block element request with null values as no block of text had been selected by the user as confirmed from block 420. Then the LDPI 132 proceeds with block 450.

In block 450, the LDPI 132 sends the request as instantiated in either block 430 or block 440 to the literary device system (LDS) 150 such that a response corresponding to the request may be generated for the user. Then the LDPI 132 proceeds with block 460.

In block 460, the LDPI 132 receives the response corresponding to the request sent in block 450 from the LDS 150. Then the LDPI 132 proceeds with block 470.

In block 470, the LDPI 132 configures the response received in block 460 as generated by the LDS 150 to be properly displayed in the user node 130, and subsequently sends the configured response to the UI 131 such that the response is delivered to the user who submitted the request in block 410. Then the LDPI 132 terminates processing the request. The LDPI 132 may iterate the process in blocks 410 through 470 upon being triggered by another request from the user.

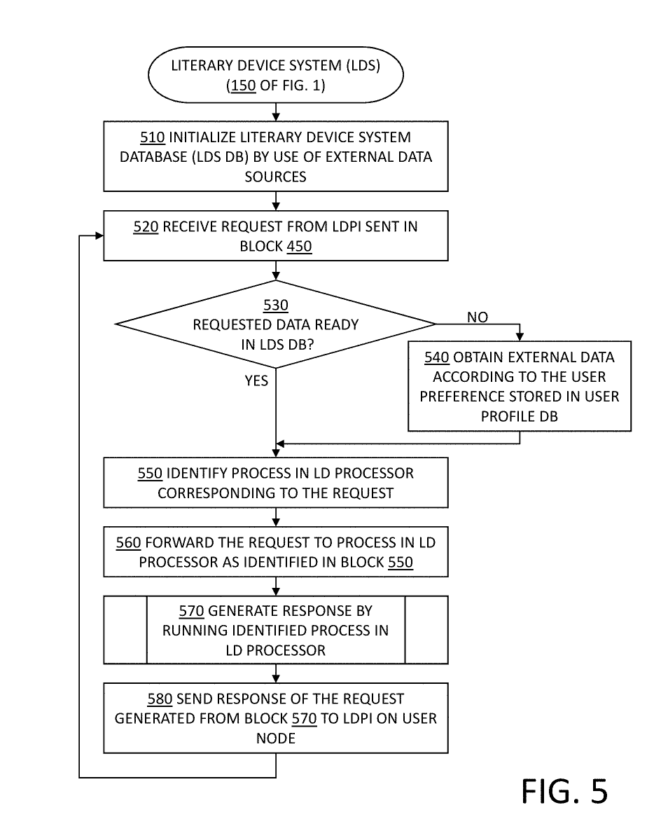

FIG. 5 depicts a flowchart for the literary device system (LDS) 150 of FIG. 1, in accordance with one or more embodiments set forth herein.

Prior to block 510, the user successfully subscribed the literary device system (LDS) 150, and has a user profile stored in the user profile database 167 of FIG. 1. Although not described in FIG. 5, the LDS 150 authenticates the user who originates the request of block 520, upon receiving the request by checking credentials associated with the user as stored in the user profile database 167.

In block 510, the LDS 150, by use of the external literary source process 178, initializes the literary device system database (LDS DB) 179 of FIG. 1 based on the literary analysis sources 185 to train the character assessment process 172 and the literary device analyzer 173 of the literary device (LD) processor 170. Then the LDS 150 proceeds with block 520.

In block 520, the LDS 150, by use of the literary device (LD) interface 161 of FIG. 1, receives the request from the literary device plug-in (LDPI) 132 of FIG. 1 that had been sent in block 450 of FIG. 4. Then the LDS 150 proceeds with block 530.

In another embodiment of the present invention, block 510 may be performed after block 520 wherein the request is made for the first time for a certain literary text.

In block 530, the LDS 150, by use of the LD interface 161, determines whether or not data necessary to respond to the request received in block 520 is ready within the LDS DB 179. If the LDS 150 determines that the data to form a response to the received request is stored in the LDS DB 179, then the LDS 150 proceeds with block 550. If the LDS 150 determines that the received request must be responded with data extra to the LDS DB 179, then the LDS 150 proceeds with block 540.

In block 540, the LDS 150 obtains external data according to user preference of the user profile as stored in the user profile DB 167. In one embodiment of the present invention, the LD interface 161 examines the request and the user profile to identify which source, among the social media feeds 181 and the news and media feeds 183, should be accessed to collect the data for the request, and invokes the social media process 176 or the events process 177 according to the source as identified earlier, to obtain the data for the request. The process invoked by the LD interface 161, either the social media process 176 or the events process 177, stores the obtained external data in the LDS DB 179, which is kept for a period of time as specified by system default of the LDS 150 or by user preference stored in the user profile DB 167. Then the LDS 150 proceeds with block 550.

At the beginning of block 550, the data necessary to respond to the request received in block 520 is ready in the LDS DB 179. In block 550, the LDS 150, by use of the LD interface 161, identifies a process in the LD processor 170 that is the best equipped to process the request and to generate the response for the request. Then the LDS 150 proceeds with block 560.

In block 560, the LDS 150, by use of the LD interface 161, invokes the process of the LD processor 170 identified in block 550 with the request as a parameter. Then the LDS 150 proceeds with block 570.

In block 570, the LDS 150, by running the process of the LD processor 170 identified in block 550, generates the response corresponding to the request received in block 520. The processes of the LD processor 170 updates the LDS DB 179 with the response as generated and/or with information gathered for generating the response. Then the LDS 150 proceeds with block 580.

In one embodiment of the present invention, the LDS 150 performs initial setup processes prior to accepting requests from the user, by the external literary source process 178 importing data from the literary analysis sources 185 to establish the LDS DB 179 as well as to train the processes of the LD processor 170 to generate responses for the requests. Examples of the external literary sources 185 may include CliffNotes and SparkNotes. The LD interface 161 in the LDS 150 directs requests for personality assessment, as shown in the characters 220 menu item of FIG. 2, to the character assessment process 172, requests for other literary devices, as shown in the themes 210, the settings 230, the metaphors 240, the similes 250, and the foreshadowing 260 menu items of FIG. 2, to the literary device analyzer 173, and requests for images, as shown in the images 270 menu item of FIG. 2, to the image classifier 174.

The character assessment process 172 of the LD processor processes personality assessment metadata as stored in the LDS DB 179 to generate a personality assessment response for a specific character whose personality assessment had been requested in the request. Prior to processing requests to the LDS 150, the external literary source process 178 initially sets up the LDS DB 179 with metadata for basic literary analysis information from the literary analysis sources 185. In another embodiment of the present invention, the character assessment process 172, upon receiving a request for personality assessment, determines if the literary analysis sources 183 should be revisited for more personality information for the specific character inquired in the request, or if the personality assessment response may be made by information stored in the LDS DB 179.

The image classifier 174 of the LD processor 170 processes images relevant to the literary text, including illustrations or figures appearing in the literary text, images from external data sources of the social media feeds 181 and the news and media feeds 183. The LDS 150 initially examines the literary text for images, and the image classifier 174 is invoked for processing the discovered images by utilizing tags placed on images by an author of the literary text, by a system administrator of the LDS 150, by AlchemyAPI® that performs classifying and comparing of the images (AlchemyAPI is a registered trademark of International Business Machines, Corporation in the United States and other countries). As other processes of the LD processor 170, the image classifier 174 updates the LDS DB 179 with a result of processing the images.

For example, wherein the user of the literary device system (LDS) 150 selects a third option “Social Media Image” from the pop-up menu of the image classifier 332 of FIG. 3C, the LD interface 161 generates a request to obtain images similar to the image subject to the request, the figure of the Roman Colosseum 334 of FIG. 3C. The user profile, as being stored in the user profile DB 167 corresponding the user submitting the request, specifies from which social media sites the user wishes to obtain a certain type of images, how often the user wishes to collect the images, and for how long the user wishes to keep the collected images in the LDS 150. According to the aforementioned configuration preferred by the user governing collection of social media images, the social media process 176 automatically collects images and stores the collected images in the LDS DB 179 for a later use by the image classifier 174. During the automated collection of images, the social media process 176 may further process the images by AlchemyAPI for classification and comparison of the images.

The events process 177 of the LD processor 170 processes the news and media feeds 183 pursuant to a news gathering configuration of the LDS 150 that specifies which news media should be looked at, how much weight is given to respective news media, or pursuant to a user configuration for news gathering as enabled by the LDS 150 such as a keyword search/scan of the news and media feeds 183, a preferred frequency of the keyword search/scan, as well as which media should be examined, etc. Specifics of user-configured searches such as keywords, frequencies, a list of media to be searched, etc., are stored in the user profile DB 167, as in the case for user preference for data collection from the social media feeds 181. Similar to the requests for social media images presented above, the events process 177 determines whether the request should be processed with the data in the LDS DB 179 or the news and media feeds 183 subject to searches/scans should be revisited for the latest information, which will be updated into the LDS DB 179 as the events process 177 generates the response corresponding to the request.

In block 580, the LDS 150, by use of the LD interface 161, sends the response generated in block 570 to the LDPI 132 of the user node 130, which will be received in block 460 of FIG. 4. Then the LDS 150 terminates processing the request received in block 520. The LDS 150 iterates blocks 520 through 580 of FIG. 5 upon receiving another request.

FIG. 6A is a listing of metadata for the literary analysis sources 185 stored in the literary device system database 179 by the external literary source process 178 of FIG. 1, in accordance with one or more embodiments set forth herein.

In one embodiment of the present invention, metadata is generated in Extensible Markup Language (XML) format. Tags in the lines L601 <major theme> and L605 </major theme> mark where the root element “major theme” begins and ends, respectively. Within the major theme element, line L602 represents a first subelement “reference” having an instance “Chapter 1, section 1, paragraph 2, sentences 1-4”, indicating that the major theme element may be revealed by the instance of the first subelement reference. Within the major theme element, line L603 represents a second subelement “reference” having an instance “Chapter 1, section 1, paragraph 30, sentences 1-1”, indicating that the major theme element may be revealed by the instance of the second subelement reference. Similarly within the major theme element, line L604 represents a third subelement “reference” having an instance “Chapter 3, section 2, paragraph 7, sentences 1-6”, indicating that the major theme element may be revealed by the instance of the third subelement reference.

FIG. 6B is a data type definition of a request for a literary device and a response corresponding to the request, in accordance with one or more embodiments set forth herein.

In line L631, the request for a literary device is defined as a function named “requestDevice ( )”, having a first parameter “deviceElement” indicating a name of the literary device requested, a second parameter “blockText” indicating a block of text subject to analysis in processing the request as selected by the user, and a third parameter “resultingDevice” indicating a format of a response corresponding to the request.

In line L632, the first parameter “deviceElement” is defined as of a string data type.

In lines L633 through L641, the second parameter “blockText” is defined as of a “blockStructure” type, which is further defined as a set of eight (8) numbers marking a range of a text block, respectively referred to as “starting chapter number” in line L634, “ending chapter number” in line L635, “starting section number” in line L636, “ending section number” in line L637, “starting paragraph number” in line L638, “ending paragraph number” in line L639, “starting sentence number” in line L640, and “ending sentence number” in line L641.

In line L651 the third parameter “resultingDevice” is defined as of a “resultingBlockStructure” type, which is further defined as a string component “theme” in line L652, a set of eight (8) numbers marking a range of a text block in which the “theme” component is revealed, with identical number elements in the “blockStructure” type in lines L653 through L660, and a Boolean flag “another find” in line L661 indicating whether or not the “theme” component has been found in another text block additional to the text block marked in a preceding set of eight (8) numbers.

FIG. 6C depicts examples of requests for a literary device and responses corresponding to the requests pursuant to the data type definition of FIG. 6B, in accordance with one or more embodiments set forth herein.

In line L671, a first request for a literary device “Theme” is submitted for a text block “1, 1, 1, 1, 1, 5, 1, 10”, that is, from chapter 1, section 1, paragraph 1, sentence 1 to chapter 1, section 1, paragraph 5, sentence 10 that had been selected by the user. The literary device plug-in (LDPI) 132 of FIG. 1 generates the first request when the user selects the text block and then selects “Themes” from the pop-up menu window 315 of FIG. 3A. As the first request does not have a response yet, a third parameter of resultingBlockStructure type is null.

In line L673, a first response corresponding to the first request in line L671 is generated. A first and a second parameters are identical to the corresponding parameters of the first request. A third parameter of resultingBlockStructure type includes a “Theme” of string type instantiated “Love is a powerful force”, which is revealed in a text block “1, 1, 1, 1, 2, 2, 1, 4”, that is, from chapter 1, section 1, paragraph 2, sentence 1 to chapter 1, section 1, paragraph 2, sentence 4, and “another find” instantiated as “N” indicating no other reference has been found within the text block as selected by the user. When the first response is returned to the LDPI 132, the text block referenced in the first response is highlighted or otherwise marked as relevant to the theme for the user.

In line L675, a second request for a literary device “Theme” is submitted with no selected text block as indicated by “null” in place for the blockStructure type component, for which the literary device analyzer 173 will generate a response based on whole text of a subject literary work. As the second request does not have a response yet, a third parameter of resultingBlockStructure type is null.

In line L677, a second response corresponding to the second request in line L675 is generated. A first and a second parameters are identical to the corresponding parameters of the second request. A third parameter of resultingBlockStructure type includes a “Theme” of string type instantiated “Love is a powerful force”, which is revealed in a first text block “1, 1, 1, 1, 2, 2, 1, 4”, that is, from chapter 1, section 1, paragraph 2, sentence 1 to chapter 1, section 1, paragraph 2, sentence 4, and a first “another find” flag instantiated as “Y” indicating another reference has been found within the subject literary work. Following the first “another find” flag instantiated as “Y”, a second text block “1, 1, 1, 1, 30, 30, 1, 1”, a second “another find” flag instantiated as “Y”, a third text block “3, 3, 2, 2, 7, 7, 1, 6”, a third “another find” flag instantiated as “Y”, and another text block represented as ellipsis ( . . . ) are presented. Similar to the first response, the text blocks referenced in the second response are highlighted or otherwise marked as relevant to the theme for the user.

Certain embodiments of the present invention may offer various technical computing advantages, including automated data collection from external data sources relevant to literatures based on user preference information, and consequently improve delay in responding to a request involving analysis of the external data sources. Certain embodiments of the present invention improve literature learning experience of users significantly without overloading computing device of the users by delegating most of computing and processing to a literary device system that operates in a cloud computing environment or a data center environment, having substantially more computing resources than computing devices of users. Further, the same embodiments of the present invention may improve efficiency of data collection and quality of literary analysis by employing analytics systems and cognitive APIs in a high capacity computing environment such as IBM® Watson Analytics™ (IBM and Watson Analytics are trademarks of International Business Machines, Corporation in the United States and other countries).

Certain embodiments of the present invention enables establishing several purpose-specific databases, including a literary device system database that retains the requests that had been processed by the literary device system and corresponding results, thus frequent requests may be best served with more contents and shorter delays. The same embodiments of the present invention utilizes machine learning from existing literary analysis sources, thus offer more comprehensive analytic results as well as enhanced experience by use of external contents.

FIGS. 7-9 depict various aspects of computing, including a computer system and cloud computing, in accordance with one or more aspects set forth herein.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 7, a schematic of an example of a computer system/cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system-executable instructions, such as program processes, being executed by a computer system. Generally, program processes may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program processes may be located in both local and remote computer system storage media including memory storage devices.

As shown in FIG. 7, computer system 12 in cloud computing node 10 is shown in the form of a general-purpose computing device. The components of computer system 12 may include, but are not limited to, one or more processors 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program processes that are configured to carry out the functions of embodiments of the invention.

One or more program 40, having a set (at least one) of program processes 42, may be stored in memory 28 by way of example, and not limitation, as well as an operating system, one or more application programs, other program processes, and program data. Each of the operating system, one or more application programs, other program processes, and program data or some combination thereof, may include an implementation of the literary device system 150 of FIG. 1. Program processes 42, as in the processes of the literary device processor 170 of FIG. 1, generally carry out the functions and/or methodologies of embodiments of the invention as described herein.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processors, external disk drive arrays, redundant array of independent disks (RAID) systems, tape drives, and data archival storage systems, etc.

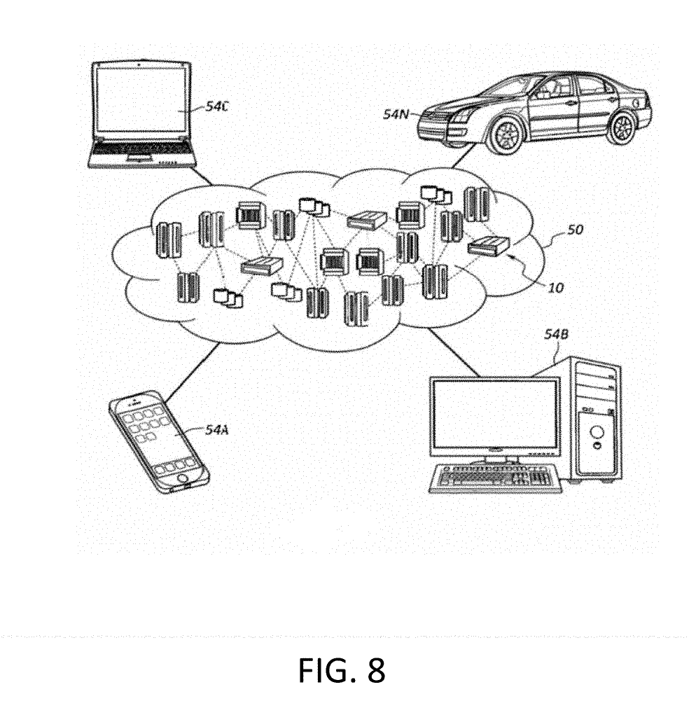

Referring now to FIG. 8, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

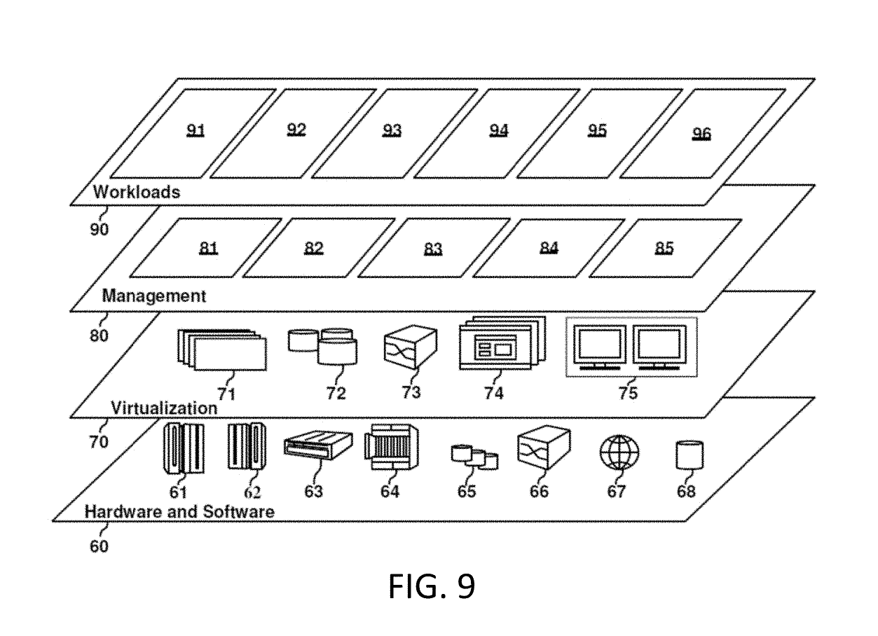

Referring now to FIG. 9, a set of functional abstraction layers provided by cloud computing environment 50 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing components for a literary device system implementing cognitive analytics of literatures and real-time collection and processing of external data relevant to the literatures 96, as described herein. The processing components 96 can be understood as one or more program 40 described in FIG. 7.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method for automatically annotating a literary text, comprising:
receiving from a user of a literary device system, by one or more processor running the literary device system, a request for a response comprising a piece of annotative data on the literary text;
ascertaining, by the one or more processor, that metadata to generate the response is available for the literary device system;
identifying, by the one or more processor, a process of the literary device system that is associated with the request;
forwarding, by the one or more processor, the request to the process;
generating, by the one or more processor, the response by the process based on the metadata; and
producing, by the one or more processor, the generated response to the user such that the user is presented with the annotative data on the literary text.

2. The computer implemented method of claim 1, further comprising:
prior to the receiving, initializing, by the one or more processor, a literary device system database of the literary device system with metadata respective to individual annotative data for a collection of annotative data gathered from external data sources, wherein the external data sources comprise one or more social media feed, one or more news media feed, and one or more literary analysis source.

3. The computer implemented method of claim 1, the ascertaining comprising:
determining, by the one or more processor, that the metadata for the annotative data on the literary text is stored in a literary device system database of the literary device system, resulting from one or more of both initial preparation of the literary device system database and dynamic update of the literary device system database based on generated responses.

4. The computer implemented method of claim 1, the ascertaining comprising:
upon determining, by the one or more processor, that the metadata for the annotative data on the literary text is not stored in a literary device system database of the literary device system, obtaining, by the one or more processor, external data from external data sources coupled to the literary device system, according to user preferences for using the external data sources, wherein the user preferences are stored in a user profile database of the literary device system, wherein the external data sources comprise one or more social media feed, one or more news media feed, and one or more literary analysis source, and wherein the user preferences dictates which one or more of the external data sources to be used for information gathering, how often the information gathering to be performed, and how long to keep results of the information gathering in the literary device system database.

5. The computer implemented method of claim 1, wherein the process of the literary device system is selected from the group consisting of a literary device analyzer, a character assessment process, an image classifier, a social media process, an events process, and an external literary source process.

6. The computer implemented method of claim 1, wherein the annotative data on the literary text is selected from the group consisting of a social media posting, a news article, a historical fact, an image, and a literary device analysis.

7. The computer implemented method of claim 1, wherein the user of the literary device system accesses the literary device system by use of a literary device plug-in and a user interface running on a user node, wherein the literary device plug-in comprises pop-up menu items including themes, characters, settings, metaphors, similes, foreshadowing, images, and more, and wherein sub-menu items of the more pop-up menu item comprise social sentiment, current events and historical events.

8. A computer program product comprising:
a computer readable storage medium readable by one or more processor and storing instructions for execution by the one or more processor for performing a method for automatically annotating a literary text, comprising:
receiving from a user of a literary device system, by the one or more processor running the literary device system, a request for a response comprising a piece of annotative data on the literary text;
ascertaining, by the one or more processor, that metadata to generate the response is available for the literary device system;
identifying, by the one or more processor, a process of the literary device system that is associated with the request;
forwarding, by the one or more processor, the request to the process;
generating, by the one or more processor, the response by the process based on the metadata; and
producing, by the one or more processor, the generated response to the user such that the user is presented with the annotative data on the literary text.

9. The computer program product of claim 8, further comprising:
prior to the receiving, initializing, by the one or more processor, a literary device system database of the literary device system with metadata respective to individual annotative data for a collection of annotative data gathered from external data sources, wherein the external data sources comprise one or more social media feed, one or more news media feed, and one or more literary analysis source.

10. The computer program product of claim 8, the ascertaining comprising:
determining, by the one or more processor, that the metadata for the annotative data on the literary text is stored in a literary device system database of the literary device system, resulting from one or more of both initial preparation of the literary device system database and dynamic update of the literary device system database based on generated responses.

11. The computer program product of claim 8, the ascertaining comprising:
upon determining, by the one or more processor, that the metadata for the annotative data on the literary text is not stored in a literary device system database of the literary device system, obtaining, by the one or more processor, external data from external data sources coupled to the literary device system, according to user preferences for using the external data sources, wherein the user preferences are stored in a user profile database of the literary device system, wherein the external data sources comprise one or more social media feed, one or more news media feed, and one or more literary analysis source, and wherein the user preferences dictates which one or more of the external data sources to be used for information gathering, how often the information gathering to be performed, and how long to keep results of the information gathering in the literary device system database.

12. The computer program product of claim 8, wherein the process of the literary device system is selected from the group consisting of a literary device analyzer, a character assessment process, an image classifier, a social media process, an events process, and an external literary source process.

13. The computer program product of claim 8, wherein the annotative data on the literary text is selected from the group consisting of a social media posting, a news article, a historical fact, an image, and a literary device analysis.

14. The computer program product of claim 8, wherein the user of the literary device system accesses the literary device system by use of a literary device plug-in and a user interface running on a user node, wherein the literary device plug-in comprises pop-up menu items including themes, characters, settings, metaphors, similes, foreshadowing, images, and more, and wherein sub-menu items of the more pop-up menu item comprise social sentiment, current events and historical events.

15. A system comprising:
a memory;
one or more processor in communication with memory; and
program instructions executable by the one or more processor via the memory to perform a method for automatically annotating a literary text, comprising:
receiving from a user of a literary device system, by the one or more processor running the literary device system, a request for a response comprising a piece of annotative data on the literary text;
ascertaining, by the one or more processor, that metadata to generate the response is available for the literary device system;
identifying, by the one or more processor, a process of the literary device system that is associated with the request;
forwarding, by the one or more processor, the request to the process;
generating, by the one or more processor, the response by the process based on the metadata; and
producing, by the one or more processor, the generated response to the user such that the user is presented with the annotative data on the literary text.

16. The system of claim 15, further comprising:
prior to the receiving, initializing, by the one or more processor, a literary device system database of the literary device system with metadata respective to individual annotative data for a collection of annotative data gathered from external data sources, wherein the external data sources comprise one or more social media feed, one or more news media feed, and one or more literary analysis source.

17. The system of claim 15, the ascertaining comprising:
determining, by the one or more processor, that the metadata for the annotative data on the literary text is stored in a literary device system database of the literary device system, resulting from one or more of both initial preparation of the literary device system database and dynamic update of the literary device system database based on generated responses.

18. The system of claim 15, the ascertaining comprising:
upon determining, by the one or more processor, that the metadata for the annotative data on the literary text is not stored in a literary device system database of the literary device system, obtaining, by the one or more processor, external data from external data sources coupled to the literary device system, according to user preferences for using the external data sources, wherein the user preferences are stored in a user profile database of the literary device system, wherein the external data sources comprise one or more social media feed, one or more news media feed, and one or more literary analysis source, and wherein the user preferences dictates which one or more of the external data sources to be used for information gathering, how often the information gathering to be performed, and how long to keep results of the information gathering in the literary device system database.

19. The system of claim 15, wherein the process of the literary device system is selected from the group consisting of a literary device analyzer, a character assessment process, an image classifier, a social media process, an events process, and an external literary source process, and wherein the annotative data on the literary text is selected from the group consisting of a social media posting, a news article, a historical fact, an image, and a literary device analysis.

20. The system of claim 15, wherein the user of the literary device system accesses the literary device system by use of a literary device plug-in and a user interface running on a user node, wherein the literary device plug-in comprises pop-up menu items including themes, characters, settings, metaphors, similes, foreshadowing, images, and more, and wherein sub-menu items of the more pop-up menu item comprise social sentiment, current events and historical events.
